(19) United States
(12) Patent Application Publication
(10) Pub. No.: US 2004/0113728 A1
(43) Pub. Date: Jun. 17, 2004

(54) Starter and magnet switch thereof

(75) Inventors: Masanori Ohmi, Anjo-city (JP); Tadahiro Kurasawa, Chita-gun (JP); Tsutomu Shiga, Nukata-gun (JP); Masami Niimi, Handa-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/721,452

(22) Filed: Nov. 26, 2003

(30) Foreign Application Priority Data
Dec. 11, 2002 (JP) 2002-359021

(51) Int. Cl. H01H 67/02

(52) U.S. Cl. 335/126

(57) ABSTRACT

A magnet switch for a starter includes a exciting coil member, a switch case, a stator core, a plunger disposed in a hollow portion of the exciting coil to confront the stator core through an air gap, a link member connected to the plunger and disposed outside the switch case, a movable contact supported and insulated by the link member to move together with the plunger; and a stationary contact disposed opposite the movable contact. The link member has a pair of arms which axially extend along outer surfaces of the switch case. The switch case, the exciting coil and the plunger respectively have elliptic cross sections. The pair of arms is disposed to extend along the minor axis of the elliptic cross section to be movable in the axial direction of the switch case along the outer surface thereof.

### CROSS REFERENCE TO RELATED APPLICATION

The present application is based on and claims priority from Japanese Patent Application 2002-359021, filed December 11, 2002, the contents of which are incorporated herein by reference.

### BACKGROUND OF THE INVENTION

1. Field of the Invention

The present invention relates to a starter for starting an internal combustion engine and its magnet switch.

2. Description of the Related Art

U.S. Ser. No. 2003/0,193,382 Al discloses a starter and its magnet switch which has a plunger and a link member disposed outside a switch case to connect the plunger with a movable contact. The link member is constituted of a flange that is fixed to the plunger and a resinous holder that is connected to the flange. The holder holds the movable contact and electrically insulates it from others.

This magnetic switch does not have a conventional connecting rod. In this magnet switch, the link member is disposed in a cylindrical switch case to diametrically extend from one wall to the opposite wall thereof. Accordingly, the link member necessarily increases the outside diameter of the magnet switch, which causes a trouble when it is mounted in a starter. It is also necessary to fix the plunger to prevent it from rotating, resulting in increasing the number of parts and cost.

### SUMMARY OF THE INVENTION

Therefore, an object of the invention is to provide an inexpensive and compact magnet switch and a starter having such an improved magnet switch.

According to a feature of the invention, a magnet switch for a starter includes a hollow exciting coil member, a switch case which covers the exciting coil, a stator core disposed at an end of the switch case, a plunger disposed in the hollow portion of the exciting coil to confront the stator core through an air gap; a link member having a pair of arms connected to the plunger and disposed outside the switch case, a movable contact supported and insulated from others by the link member to move together with the plunger and a stationary contact disposed opposite the movable contact. The movable contact contacts the stationary contact to supply electric power to a starting motor when the plunger is attracted by the exciting coil. The switch case, exciting coil and plunger respectively have generally elliptic cross sections, each of which has a major axis and a minor axis. The pair of arms is disposed outside the switch case to extend along the minor axis of the elliptic cross sections and is movable in the axial direction of the switch case along the outer surface there. Therefore, the size of the magnetic switch can be made compact. In addition, it is not necessary to provide additional member to prevent rotation of the link member because the link member is guided or supported by the switch case whose cross section is not circular but elliptic.

In the above featured magnet switch, the switch case may have a pair of flat outside surfaces, along which the pair of arms move. Therefore, it is easy to manufacture the link member having flat surfaces to be guided by the switch case.

The link member may include a flange connected to the other end of the plunger and an insulating holder which supports opposite sides of the movable contact.

According to another feature of the invention, a starter to be connected to an engine ring gear includes a housing, a starting motor disposed in the housing, an output shaft with a pinion being connected to the shaft by helical spline connection to be driven by the starting motor, the above described magnet switch, a pinion control member connected to the pinion, a crank bar having one end connected to the plunger and the other end connected to the pinion control member. The pinion is driven forward along the output shaft to engage the engine ring gear when the pinion control member restricts rotation of the pinion, due to reaction of the helical spline connection. It is not necessary to have additional means for thrusting the pinion to the engine ring gear.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a cross-sectional side view of a starter according to a preferred embodiment of the invention;

FIG. 2 is a circuit diagram of the starter shown in FIG. 1;

FIG. 3 is a cross-sectional view of a magnet switch shown in FIG. 1; and

FIG. 4 is a perspective exploded diagram of a switch case, a plunger and a flange of the magnet switch according to the preferred embodiment of the invention.

### DETAILED DESCRIPTION OF THE PREFERRED EMBODIMENTS

A starter according to a preferred embodiment of the invention will be described with reference to the appended drawings.

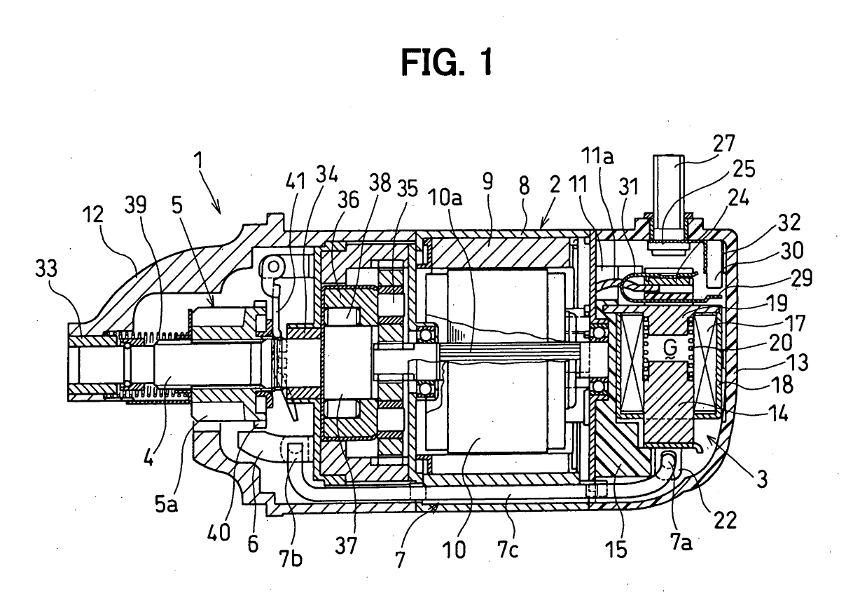

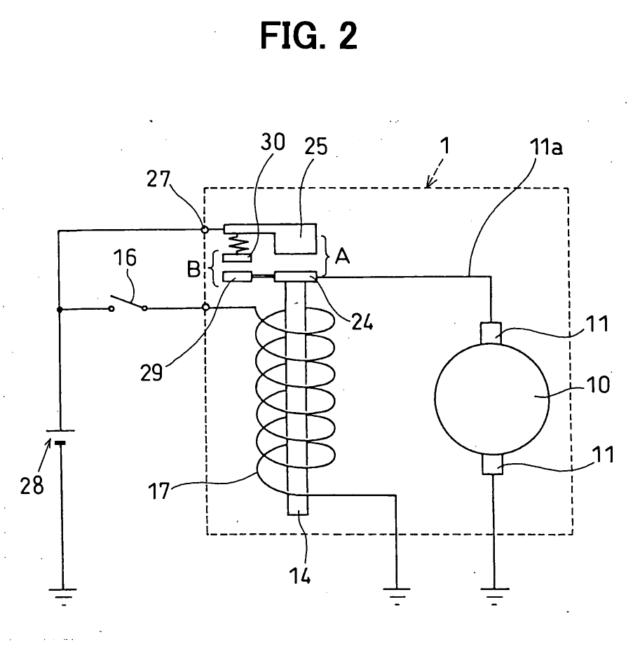

As shown in FIG. 1, a starter 1 according to a preferred embodiment of the invention includes a starting motor 2, a magnet switch 3 which turns on or off a circuit for supply electric power to the starting motor 2, an output shaft 4 which is driven by the starting motor 2, a pinion 5 disposed around the output shaft 4 to slide along the output shaft 4, a pinion control member 6 which controls rotation of the pinion when the starting motor 2 operates, a crank bar 7 which drives the pinion control member 6, a front housing 12, an end cover 13, a seat member 15, etc.

The starting motor 2 is disposed between the front housing 12 and the end cover 13. The starting motor 2 is a common DC motor that is constituted of a yoke 8, a plurality of magnetic pole members (e.g. permanent magnets) 9, an armature 10, brushes 11, etc. When the magnet switch 3 closes a pair of contacts (motor switch), direct current is supplied from a battery 28 to the armature 10 via the brushes 11 to rotate the armature 10.

The magnet switch 3 is disposed at a rear portion of the starter 1 or at the rear side of the starting motor 2 and fixed to the seat member 15 by a spring band (not shown) or the like. The magnet switch 3 is constituted of a plunger 14, an exciting coil 17, a switch case 18 which covers the exciting coil 17, a stator core 19, a return spring 20, a flange 21, a hook 22, a holder 23 and a motor switch that has a first contact unit A and a second contact unit B. The plunger 14 is disposed inside the exciting coil 17 to extend in the direction parallel to the axis of the switch case 18 and perpendicular to the axis of the starting motor 2. The plunger 14 is arranged to slide along a sleeve (not shown) which is inserted between the exciting coil 17 and the plunger 14. The stator core 19 is disposed at one end of the switch case 18.

Each of the switch case 18, the exciting coil 17 and the plunger 14 has a generally elliptic cross section that has major and minor axes which are perpendicular to each other. Each cross section has parallel straight sides at opposite ends of the minor axis. That is, the switch case 18 has a cylindrical wall portion 18a and end wall portions 18b, and the cylindrical wall portion 18a has parallel flat portions 18c, as shown in FIG. 4. The exciting coil 17 and the plunger 14 also respectively have parallel flat portions.

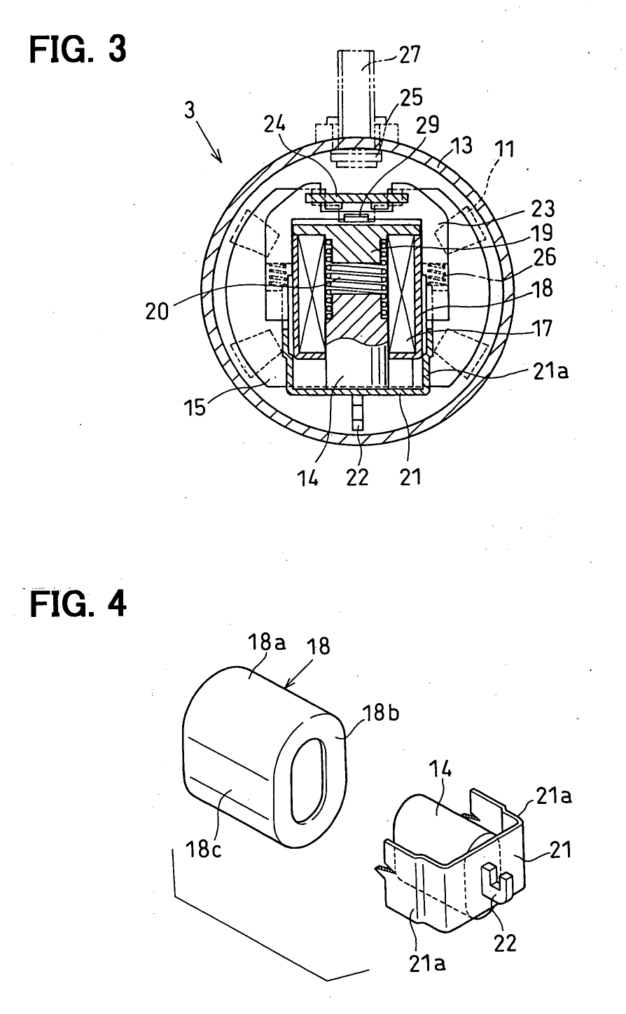

The stator core 19 has a flange portion the outer periphery of which has the same elliptic cross-section as the switch case 18 to close one open end of the switch case 18. This shape makes the magnet switch compact, and comparatively longer brushes 11 for longer life time can be installed, as shown in FIG. 3. The stator core 19 and the switch case 18 form a stationary magnetic circuit of the magnet switch 3.

The plunger 14 is disposed so that one end thereof confronts the stator core 19 through an air gap G. The plunger 14 is biased downward by the return spring 20, as shown in FIG. 3.

The hook 22 is force-fitted to the other end (lower end) of the plunger 14 together with the flange 21 to connect one end of the crank bar 7. The flange 21 has a U-shaped cross-section. The flange 21 has a pair of parallelly extending arms 21a which are disposed outside the parallel flat portions 18c of switch case 18 and the plunger 14. The pair of arms 21a is guided by the flat portions 18c to reciprocate in the axial direction of the switch case 18. Thus, the surface of the arms 21a can be made flat.

The holder 23 is made of a resinous-insulating material. The holder 23 also has a pair of arms which is connected to the arms 21a of the flange 21 outside the switch case 18 to move together. The flange 21 and the holder 23 form a link member connected to an end of the plunger 14 and disposed outside the switch case 18. Because the link member is disposed outside the parallel flat portion between which the minor axis extends, the outside diameter of the magnet switch can be made comparatively shorter. In addition, no additional member to prevent the link member from rotating is necessary.

A pair of contact springs 26 is disposed between the arms 21a of the flange 21 and the arms of the holder 23 to give biasing force to the first contact unit A when closed. The flange 21 and the holder 23 are connected so that they can move from each other via the contact springs 26.

The first contact unit A is constituted of a first movable contact 24 and a first stationary contact 25. The first movable contact 24 is disposed at a side of the stator core 19 away from the air gap G. The first movable contact 24 is held by the holder 23 at the opposite sides thereof to prevent vibration when the plunger 14 moves. The first movable contact 24 is also electrically insulated by the holder 23 and connected to the positive side of the brushes 11 by a lead wire 11a. The contact springs 26, which are disposed between the flange 21 and the holder 23, give a contact pressure on the stationary contact 25 when the movable contact 24 contacts the stationary contact 25.

The first stationary contact 25 is disposed to confront the first movable contact 24 and connected to a head of a terminal bolt 27 which penetrates the end cover 13. The terminal bolt 27 is connected to the battery 28 via a battery cable.

The second contact unit B is constituted of a second movable contact 29 and a second stationary contact 30. As shown in FIG. 1, the second movable contact 29 is supported by the holder 23 via an elastic conductor plate 31, such as a copper plate. The conductor plate 31 provides a contact pressure, as a contact spring, when the second movable contact 29 contacts the second stationary contact 30. The second stationary contact 30 is disposed to confront the second movable contact 29 and connected to the terminal bolt 27 via a conductor plate 32. The second stationary contact 30 is made of a material, such as carbon, whose resistance is larger than the first stationary contact 25.

The first contact unit A and the second contact unit B are to control the rotation speed of the armature 10 when the starting motor 2 is operated. For this purpose, the second contact unit B turns on before the first contact unit A turns on. That is, the distance between the second movable contact 29 and the second stationary contact 30 is arranged to be smaller than the distance between the first movable contact 24 and the first stationary contact 25 while the plunger 14 stays at its initial position, as shown in FIG. 1.

The output shaft 4 is disposed in front (left in FIG. 1) of the starting motor 2 to be coaxial with the armature shaft 10a and is supported by a pair of bearings 33, 34. The output shaft 4 has an external helical spline on its outer surface and is rotated by the armature 10 via a speed reduction unit and a one-way clutch.

The speed reduction unit is a planetary gear type speed reduction mechanism that includes a planetary gears and a sun gear.

The one way clutch is a centrifugal roller type clutch that includes a clutch outer member 36, a clutch inner member 37 and a plurality of rollers 38 disposed between the outer and inner members 36, 37.

The pinion 5 has a pinion gear 5a, a brim 40 and a bore in which an internal helical spline is formed. The output shaft 4 is inserted into the pinion 5 and is spline-connected via the internal and the external helical splines. The pinion 5 is biased by a pinion spring 39 to the right in FIG. 1, in a direction to disengage the pinion from a ring gear of an engine (not shown).

The brim 40 of the pinion 5 has a plurality of notches on the periphery thereof. A retaining ring 41 is disposed at the rear of the pinion 5 to prevent the pinion 5 from moving backward when the pinion 5a engages the ring gear. The pinion control member 6 is located at a position around the brim 40 of the pinion 5 so that it can engage one of the notches of the brim 40 to restrict rotation of the pinion 5 when the motor 2 rotates.

The crank bar 7 is a metal round bar that has an L-shaped driven end 7a, an L-shaped drive end 7b and a straight middle portion 7c. The driven end 7a engages the hook 22 of the plunger 14 to transmit the attracting force of the magnet switch 3 to the drive end 7b via the straight middle portion 7c. The straight middle portion 7c extends in parallel with the armature shaft 10a between adjacent two of the magnetic pole members 9 and rotatably supported by a pair of bearings (not shown). The drive end 7b is connected to the pinion control member 6 to move the same upward in FIG. 1 when the driven end 7a is rotated by the attracted plunger 14 of the magnet switch 3.

The operation of the starter according to the preferred embodiment invention will be described below.

When the IG switch 16 is turned on, direct current is supplied from the battery 28 to the exciting coil 17 of the magnet switch 3 to generate a magnetic field. Consequently, the plunger 14 is attracted by the magnetic field to move toward the stator core 19 against the return spring 20. As the plunger moves, the crank bar 7 rotates to move the pinion control member 6 upward to engage one of the notches of the brim 40. Thus, the rotation of the pinion 5 is restricted.

On the other hand, when the plunger 14 is attracted and moves upward, the second contact unit B are turned on (the second movable contact 29 and the second stationary contact 30 are closed). As a result, a limited amount of current is supplied from the battery, so that the armature 10 rotates at a low speed. The rotation of the armature 10 is transmitted to the output shaft 4 through the one way clutch after the speed thereof is reduced by the speed reduction unit. Consequently, the pinion 5, the rotation of which is restricted by the pinion control member 6, is driven to move along the output shaft 4 due to the helical spline connection.

When the pinion gear 5a engages the ring gear, the pinion control member 6 disengages from the notch of the brim 40 and enters a space at the rear of the retaining ring 41. Thus, the pinion 5 is freed from the rotation control and prevented from moving backward.

Thereafter, the plunger 14 further moves to turn on the first contact unit A (the first movable contact 24 and the first stationary contact 25 are closed). Consequently, the second contact unit B is short-circuited and a large amount of current is supplied to the armature 10, so that the armature rotates at a high speed to crank the engine via the pinion gear 5a and the ring gear.

Thereafter, the engine starts, and the IG switch is turned off. Consequently, current supplied to the exciting coil 3 of the magnet switch 3 is stopped, and the magnetic field disappears. Therefore, the plunger 14 is returned to the initial position by the return spring 20, and the crank bar rotates in the opposite direction to bring the pinion control member back from the space at the back of the retaining ring 14. As a result, the pinion 5 is returned to the initial stationary position along the output shaft 4 by the pinion spring 39 and the driving force of the ring gear.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A magnet switch for a starter comprising:
a hollow exciting coil member which provides a magnetic field when energized;
a switch case which covers the exciting coil;
a stator core disposed at an end of a portion of the switch case in the axial direction thereof;
a plunger disposed in the hollow portion of said exciting coil, said plunger having an end which confronts said stator core through an air gap;
a link member connected to the other end of said plunger and disposed outside said switch case, said link member having a pair of arms which axially extend along radially opposite outer surfaces of said switch case;
a movable contact supported and insulated from others by said link member to move together with said plunger; and
a stationary contact disposed opposite said movable contact;
whereby said movable contact contacts said stationary contact to supply electric power to a starting motor when said plunger is attracted by said exciting coil being energized,
wherein said switch case, said exciting coil and said plunger respectively have elliptic cross sections, and
wherein said link member is disposed so that the pair of arms thereof is disposed to extend along the minor axis of the elliptic cross sections and is movable in the axial direction of said switch case along the outer surface thereof.

2. The magnet switch as claimed in claim 1,
wherein said switch case has a pair of flat surface in the direction parallel to the minor axis, and
wherein said link member is disposed outside said flat surfaces so that the pair of arms moves along said flat surfaces.

3. The magnet switch as claimed in claim 1,
wherein said link member comprises a flange connected to the other end of said plunger and a holder made of insulating material, said holder supporting opposite sides of said movable contact.

4. The magnet switch as claimed in claim 2,
wherein said link member comprises a flange connected to the other end of said plunger and a holder made of insulating material, said holder supporting opposite sides of said movable contact.

5. A starter to be connected to an engine ring gear comprising:
a housing;
a starting motor disposed in said housing;
an output shaft and a pinion that are disposed at an end of said housing, said output shaft and pinion being connected by helical spline connection to be driven by said starting motor;
a magnet switch claimed in claim 1, said magnet switch disposed at the other end of said housing;
a pinion control member connected to said pinion;
a crank bar having one end connected to the other end of said plunger and the other end connected to said pinion control member to transmit motion of said plunger to said pinion control member;
whereby said pinion is driven from said output shaft to engage the engine ring gear under the helical spline connection when said pinion control member controls rotation of said pinion.

6. The starter as claimed in claim 5, further comprising a cover which covers said magnet switch.
